(19) United States
(12) Patent Application Publication
(10) Pub. No.: US 2016/0371141 A1
(43) Pub. Date: Dec. 22, 2016

(54) MATCHED SYNDROME ERROR CORRECTION

(71) Applicant: Microsoft Technology Licensing, LLC, Redmond, WA (US)

(72) Inventor: Andrew David Daniel, Palo Alto, CA (US)

(21) Appl. No.: 14/746,356

(22) Filed: Jun. 22, 2015

(51) Int. Cl. G06F 11/10; H04L 1/00

(52) U.S. Cl. CPC G06F 11/1004; H04L 1/0061

(57) ABSTRACT

A system and method are disclosed for detecting and correcting data errors. The system analyzes a transmitted data stream and generates a transmitted primary code from the transmitted data stream. The transmitted primary code may be sent in association with the transmitted data stream. The system further analyzes the data stream as received and generates a received primary code from the received data stream. Comparison of the transmitted and received primary codes may be used to detect and correct one bit and generally multiple bit data errors in the received data stream.

### BACKGROUND

In recent years, there have been marked increases in memory storage capacity and data transmission speeds. Additionally, software applications and platforms built today make use of large amounts of data. These factors have resulted in more data being transmitted and stored than ever before. When transmitting data or retrieving data from memory, it may be important that the integrity of the data be maintained. A data error may result in an application crashing or the need to replace a non-volatile memory. Various hardware and software systems are known for detecting and correcting data errors, for example in the transmission of data. These systems are often able to detect and correct a single error, and at times multiple errors, in a transmitted data stream, but with a significant tradeoff the amount of data that needs to be transmitted and/or stored.

### SUMMARY

Embodiments of the present technology relate to a system and method for detecting and correcting data errors. In embodiments, the present technology analyzes a data stream of arbitrary length and generates what is referred to herein as a primary code for the data stream. The primary code may be transmitted in association with the data stream and may be used to detect and correct one bit and generally multiple bit data errors in the transmitted data stream.

In embodiments, the primary code includes what is referred to herein as a “ones” code and a “sum code”. Each bit in a data stream may be assigned a unique index based on its position in the stream. The first bit may be assigned an index of 1, the second bit may be assigned an index of 2 and so on. In embodiments, the sum code is defined as the sum of all index values for ‘1’ bits in the data stream. In embodiments, the ones code is a count of the number of ‘1’ bits in the data stream. The original data stream that gets transmitted may be used to generate a transmitted sum code and ones code that get sent with the transmitted data stream. After transmission, the received data stream may be used to generate a received sum code and ones code. The received sum code and ones code may be derived from the received data stream in the same manner that the transmitted sum code and ones code are derived from the transmitted data stream.

By comparing the transmitted and received sum codes and ones codes, errors in the data may be detected. For example, where the transmitted and received sum codes and ones codes are the same, the data may be assumed to have been transmitted without error. Where the transmitted and received ones codes differ by 1, one (or other odd number) of the transmitted bits is/are corrupt. In this instance, the corrupt bit(s) may be indicated by the sign and magnitude of the difference between the transmitted and received sum codes. This difference is referred to herein as the syndrome of the transmitted and received sum codes.

Data errors in multiple bits may be detected and possibly corrected by dividing the bit stream into an arbitrary number of substreams, and then deriving the transmitted and received sum codes and ones codes for each substream independently of each other. A difference of 2 between the transmitted and received ones codes may indicate two corrupt bits in the stream. A difference of zero between the transmitted and received ones codes together with a non-zero difference in the transmitted and received sum codes may also indicate two corrupt bits in the stream. The locations of the corrupt bits may be determined by analysis of the differences in the transmitted and received sum codes for the respective substreams.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is high level flowchart of an embodiment of the present technology.

FIG. 2 is a flowchart providing more detail of step 200 of FIG. 1.

FIG. 3 is an example transmitted data stream according to embodiments of the present technology.

FIG. 4 illustrates index values assigned to the respective bits of the data stream of FIG. 3.

FIG. 5 is a flowchart for identifying single bit errors in a transmitted data stream according to embodiments of the present technology.

FIG. 6 is an example of the data stream of FIG. 3 after transmission including a single bit error.

FIG. 7 illustrates index values assigned to respective bits of the data stream of FIG. 6.

FIG. 8 is a further example of the data stream of FIG. 3 after transmission including a single bit error.

FIG. 9 illustrates index values assigned to respective bits of the data stream of FIG. 8.

FIG. 10 is a further example of the data stream of FIG. 3 after transmission including two bit errors.

FIG. 11 illustrates index values assigned to respective bits of the data stream of FIG. 10.

FIG. 12 is a flowchart for identifying two bit errors in a transmitted data stream according to embodiments of the present technology.

FIG. 13 is an example of a transmitted data stream according to embodiments of the present technology.

FIG. 14 illustrates index values assigned to respective bits of the data stream of FIG. 13.

FIG. 15 is the example data stream of FIG. 13 together with a primary code as received.

FIGS. 16 and 17 are examples the data stream of FIG. 15 and associated index values as received including two bit errors.

FIG. 18 is an example data stream of FIG. 15 with the 2 error bits identified according to embodiments of the present technology.

FIGS. 19 and 20 illustrate a data stream and associated index values as in FIG. 13 with bits rotated to shuffle the corresponding substreams.

FIG. 21 is a block diagram of an illustrative computing system for implementing aspects of the present technology.

### DETAILED DESCRIPTION

Embodiments of the present technology will now be described with reference to the figures, which in embodiments relate to a system and method of detecting and correcting data errors in a received data stream. In embodiments, an original data stream may be used to generate a primary code which is sent with the original data stream. The original data stream that is sent, and primary code derived therefrom, are referred to herein as the transmitted data stream and transmitted primary code. Data errors may occur in the sending (or storing) of the transmitted data stream and primary code. Upon receipt, the received data stream may be used to generate a received primary code in the same manner as the transmitted primary code was generated from the transmitted data. By comparing the transmitted and received primary codes for the transmitted/received data streams, single and multiple bit data errors may be detected and typically corrected.

Derivation and comparison of the transmitted and received primary codes as explained below according to the present technology improves the efficiency and accuracy of computing devices working with the transmitted values. For example, the present technology can detect data errors which may otherwise result in faulty data transmission, the crashing of a computing application and/or removal of a non-volatile memory.

In embodiments, a first computing system may calculate the transmitted primary code, and send the transmitted data stream and transmitted primary code. A second computing system may receive the received data stream and calculate the received primary code. In further embodiments, a single computing system may calculate the transmitted primary code, and store or otherwise process the transmitted data stream and transmitted primary code. The same computing system may then retrieve the received data stream which has been stored or processed and calculate the received primary code for comparison against the transmitted primary code.

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely in hardware, entirely in software (including firmware, resident software, micro-code, etc.) or combining software and hardware implementations that may all generally be referred to herein as a “routine.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device. A computer readable storage medium does not include transitory, modulated or other types of signals

Computer program code for carrying out operations for aspects of the present disclosure may be written in any combination of one or more programming languages, including an object oriented programming language such as Java, Scala, Smalltalk, Eiffel, JADE, Emerald, C++, CII, VB.NET, Python or the like, conventional procedural programming languages, such as the “c” programming language, Visual Basic, Fortran 2003, Perl, COBOL 2002, PHP, ABAP, dynamic programming languages such as Python, Ruby and Groovy, or other programming languages. The program code may execute on a client device of a user, a computing system remote from a user such as a centralized server, or partly on the client device and partly on the centralized server. The centralized server may be connected to the user's client device through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, processor other programmable data processing apparatus, or other devices to function in a particular manner, such that the instructions when stored in the computer readable medium produce an article of manufacture including instructions which when executed, cause a computer or processor to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process. In this event, the instructions which execute on the computer or other programmable apparatus provide processes for implementing the functions/acts specified in the flowchart and/or block diagram block or blocks.

### Single Bit Error Correction

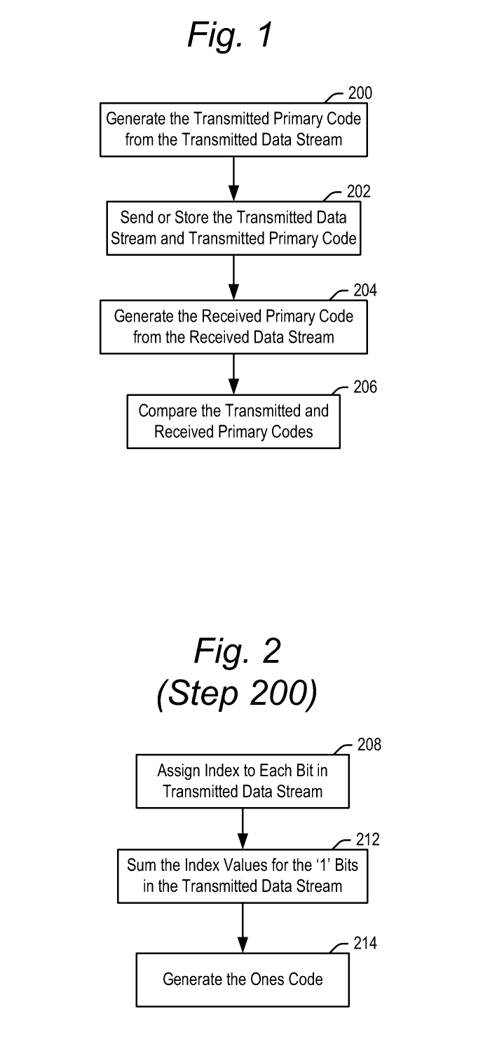

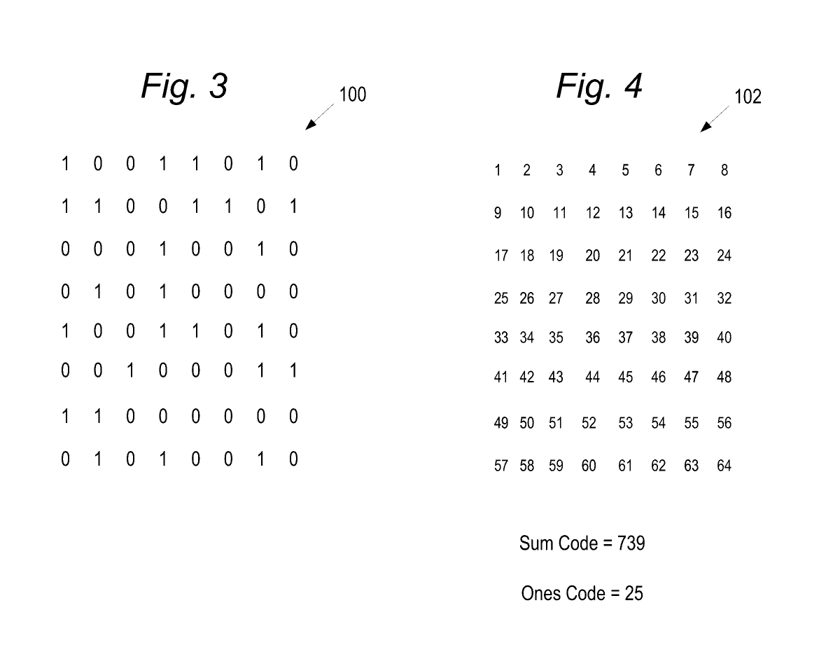

In accordance with aspects of the present technology described with respect to the flowchart of FIG. 1, a data stream of arbitrary length may be used to generate a transmitted primary code in step 200. In embodiments, step 200 may be performed by what is referred to herein as a transmitter routine within a transmitting computing system. The transmitted primary code may include a transmitted sum code and a transmitted ones code. As shown in the flowchart of FIG. 2, in order to generate the transmitted sum code from the transmitted data stream, each bit in the data stream is assigned a unique index based on its position within the stream (step 208). FIG. 3 illustrates a transmitted data stream 100 having a length of 64 bits. As indicated, the bit length may be longer or shorter than that in further examples. Each of the bits in data stream 100 is assigned a unique, non-zero index 102 as shown in FIG. 4. In embodiments, the index values may ascend numerically as shown, but they need not in further embodiments as long as each index is unique and non-zero, and that the assigned index values remain associated with the same respective bits in the transmitted and received data streams.

In step 212, the index values for the ‘1’ bits in the transmitted data stream are summed to provide the transmitted sum code. FIG. 4 shows the index values corresponding to ‘1’ bits in the transmitted data stream 100 as being shaded Summing the shaded index values for this example results in a sum code=739. The transmitted sum code will vary depending on the length of the transmitted data stream and which values in the data stream are ‘1’ bits.

Instead of summing the index values for ‘1’ bits in the sum code, the embodiments of the present technology described herein may instead sum the index values for ‘0’ bits in the sum codes. Whichever state (‘1’ or ‘0’) is used to generate the sum codes in the transmitted data should be used to generate the sum codes in the received data as explained below. In further embodiments, the bits used for summing the index could be alternated between ‘1’ and ‘0’ bits, or summed using any arbitrary pattern of ‘1’ and ‘0’ bits, provided same pattern for summing ‘1’ and ‘0’ bits was used to generate the sum code on the received data stream as explained below.

Referring again to FIG. 2, the transmitted ones code may be generated in step 214 by counting the number of ‘1’ bits in the transmitted data stream to form the ones code. In the example of FIGS. 3 and 4, the ones code=25. Instead of summing the ‘1’ bits in the ones code, embodiments of the present technology described herein may instead sum the ‘0’ bits. Whichever state (‘1’ or ‘0’) is used to generate the ones code in the transmitted data should be used to generate the ones code in the received data as explained below. In further embodiments, the bits used for summing the ones code could be alternated between ‘1’ and ‘0’ bits, or summed using any arbitrary pattern of ‘1’ and ‘0’ bits, provided same pattern for summing ‘1’ and ‘0’ bits is used to generate the ones code on the received data stream as explained below.

The steps for deriving the transmitted sum code and ones code may be expressed algorithmically as follows:
sum_code=0
bit_position=0
foreach input bit
   bit_position=bit_position+1
   if (bit==1)
      sum_code=sum_code+bit_position
      ones_code=ones_code+1

Referring again to FIG. 1, the transmitted data stream may be sent together with the transmitted primary code including the transmitted sum code and ones code in step 202. In step 204, the data stream as received (“received data stream”) may be used to generate a received primary code. The received primary code may include a received sum code and a received ones code. The received sum code and ones code may be derived from the received data stream in the same manner that the transmitted sum code and ones code were derived from the transmitted data stream.

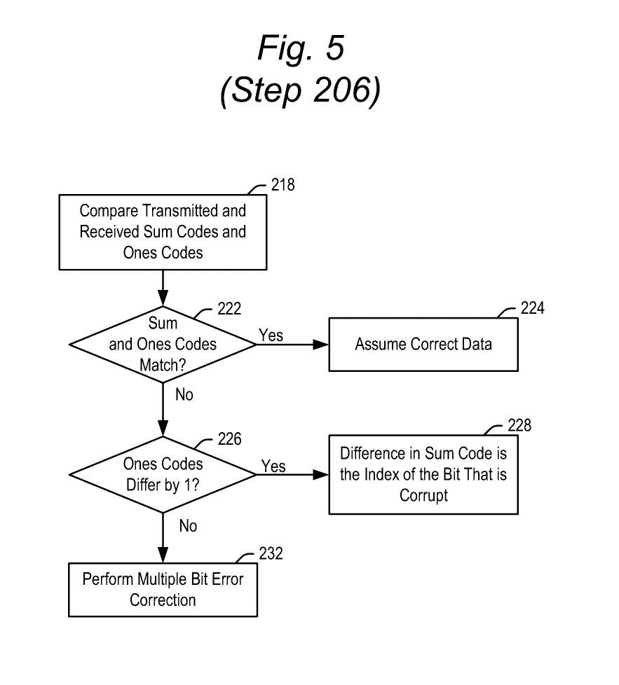

In step 206, the transmitted and received primary codes may be compared to determine if there are data errors in the received data stream. Further details of step 206 are set forth in the flowchart of FIG. 5. In step 218, the transmitted and received sum codes are compared, and the transmitted and received ones codes are compared. If the respective sum codes and one codes match each other (step 222), it may be assumed that the data has been received correctly (step 224).

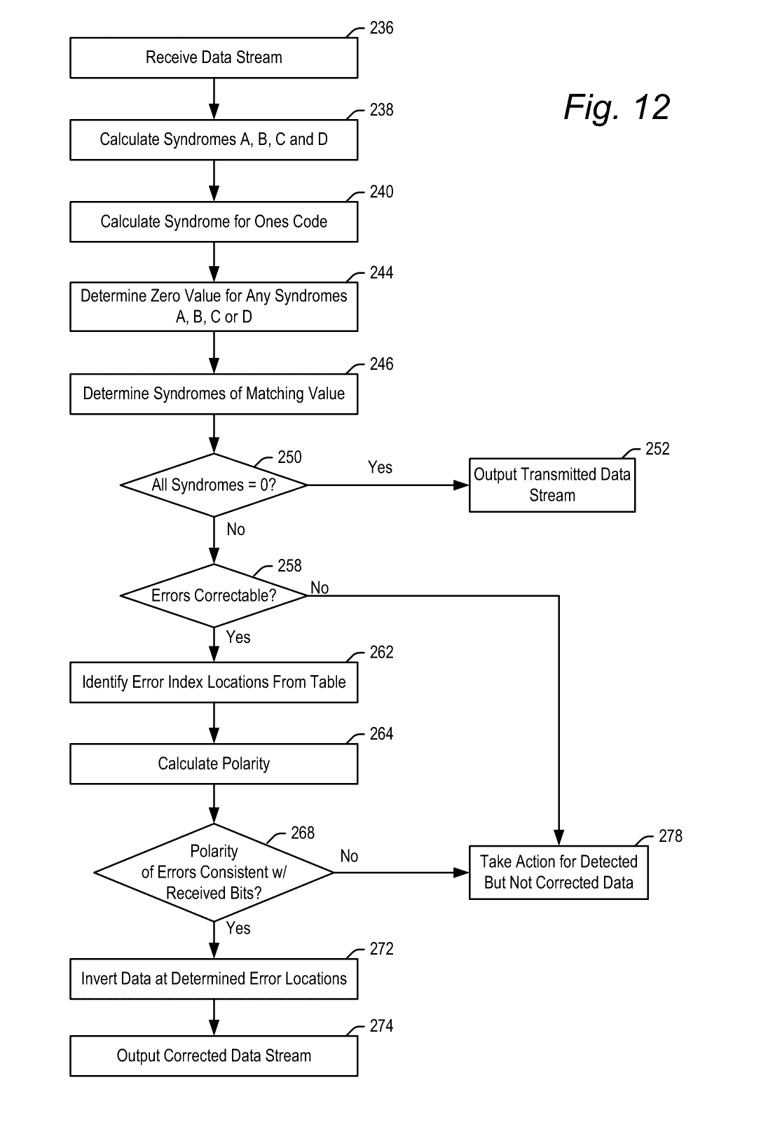

If either of the sets of codes do not match each other, step 226 checks if the transmitted and received ones codes differ by 1. If so, this is an indication that there is a single bit error, and the difference between the transmitted and received sum codes may be calculated in step 228. This difference is referred to herein as the syndrome of the transmitted and received sum codes, and will be the index of the bit that was corrupted. The bit associated with the index given by the syndrome may then be corrected. If the ones codes differ by more than one, or if the ones codes match but the sum codes differ, the assumption is that a multiple-bit error has been detected, and a multiple bit error correction routine may be performed (step 232), as explained below with respect to the flowchart of FIG. 12.

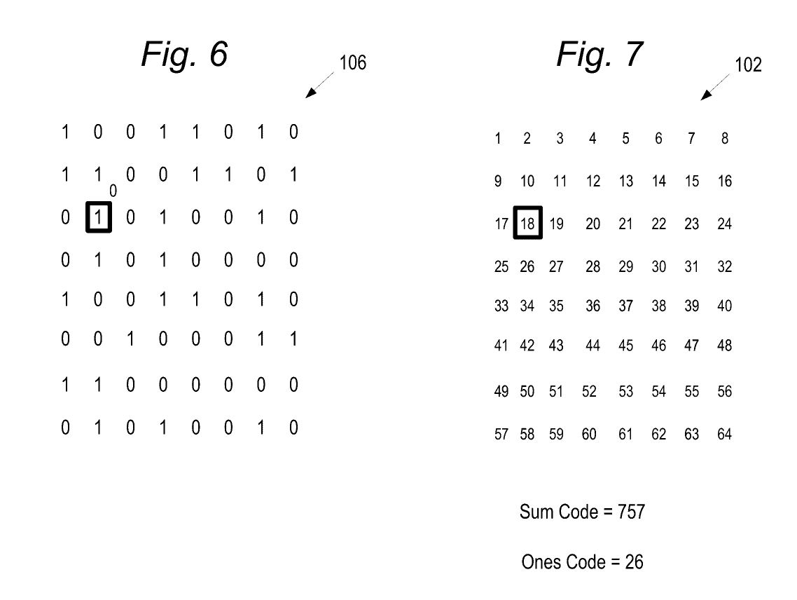

As an example, FIG. 6 illustrates the received data stream 106. Calculating the sum and ones codes as described above yields a received sum code of 757 and a received ones code of 26 as illustrated in FIG. 7. These do not match the transmitted sum/ones code values set forth in FIG. 4. The transmitted and received ones code differ by 1. Thus, the syndrome of the transmitted and received sum codes is determined:

739−757=−18

This indicates that the bit associated with the 18^{th} index is incorrect in the received data stream 106 and should be changed (from a ‘1’ to a ‘0’) to match the transmitted data stream 100.

FIG. 9 illustrates another example of the received data stream 106.

Calculating the received sum and ones codes as described above yields a sum code of 696 and a ones code of 14. These do not match the transmitted ones/sum code values set forth in FIG. 4. The transmitted and received ones code differ by 1. Thus, the syndrome of the transmitted and received sum codes is determined:

739−696=+43

This indicates that the bit associated with the 43^{rd} index is incorrect in the received data stream 106 and should be changed (from a ‘0’ to a ‘1’) to match the transmitted data stream 100.

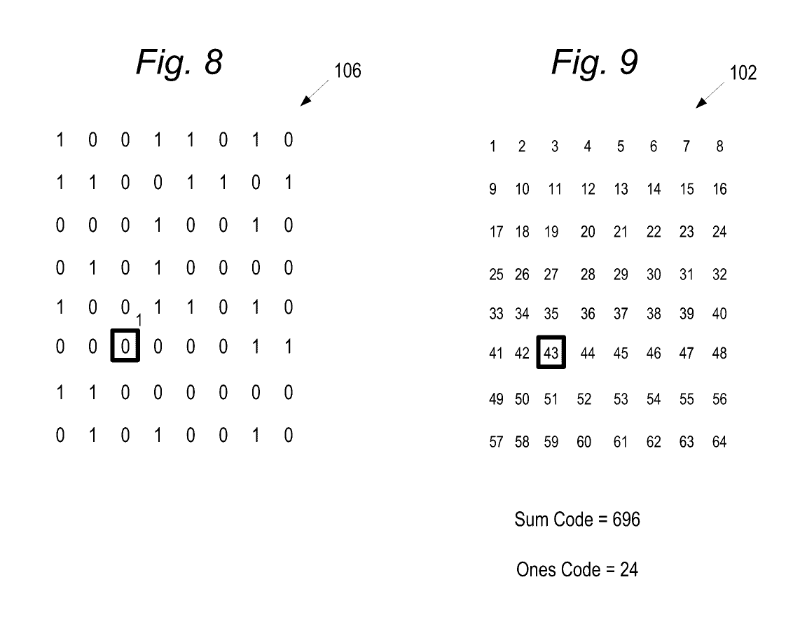

It can be noted from the examples of FIGS. 6-9 that where there is a single error bit and the received sum code is greater than the transmitted sum code, a ‘0’ bit was improperly changed to a ‘1’ bit in the received data stream. Conversely, where there is a single error bit and the received sum code is less than the transmitted sum code, a ‘1’ bit was improperly changed to a ‘0’ bit in the received data stream. This can be used as a check on the result. Specifically, in the example of FIG. 9, the error correction indicated that the 43^{rd} bit should be changed from a ‘0’ to a ‘1’. However, if the 43^{rd} bit in received data stream 106 was already a ‘1’, this would indicate that there are multiple errors elsewhere in the received data stream and that the single bit error correction described above should not be used. This condition would be detectable, but possibly not correctable.

The single bit error correction method of FIG. 5 may be expressed algorithmically as follows:

if (received_ones_code == transmitted_ones_code)

if (received_sum_code == transmitted_sum_code)

// no errors

else

// too many errors to fix

else if (abs(received_ones_code − transmitted_ones_code)> 1)

// too many errors to fix

else // fix one error

syndrome = (received_sum_code − transmitted_sum_code)
if (syndrome == 0)

// too many errors to fix

else if (syndrome < 0)

set bit at index [−syndrome] to 1

else // (syndrome >0)

set bit at index [syndrome] to 0

The single bit error correction method may also be implemented in hardware as expressed above.

The sum code described above may be determined using an adder and register of varying size, depending on the maximum block length of the data stream. However, since the largest possible index above is 8K, the largest possible single error is +/−8K and so 15 bits of accumulator are sufficient for a single error. Any higher-order bits may be ignored.

The ones code counts the number of ‘1’ bits, so in this example of 8K bits, 14 bits would suffice. However, in practice, even using far fewer bits (for instance 4) would still make the possibility of failing to detect a multiple-bit error very small.

### Multiple Bit Error Correction

The above-described technique can be adapted to support multi-bit error correction in one of several ways. One method divides the transmitted and received data streams into ‘n’ independent substreams. In particular, the transmitted data stream may be divided into n substreams. Upon receipt, the received data stream would be divided into a corresponding number of n substreams. The transmitted and received sum code and ones code for each of the n substreams may then be determined independently of each other, and the transmitted and received sum codes and ones code for each substream would be compared to each other as described above. If for example the transmitted/received data streams are divided into 4 substreams, the probability of correcting 2 bit errors in the received data stream is 75%. That is so because, as long as the two errors are in different substreams, both will be detected and corrected, and there is a 75% probability that the two errors are in different substreams. Similarly, using 8 substreams increases the probability of correcting a 2-bit error to 92.5%. However 4 substreams may use 4 pairs of transmitted codes and 8 substreams may use 8 pairs of transmitted codes.

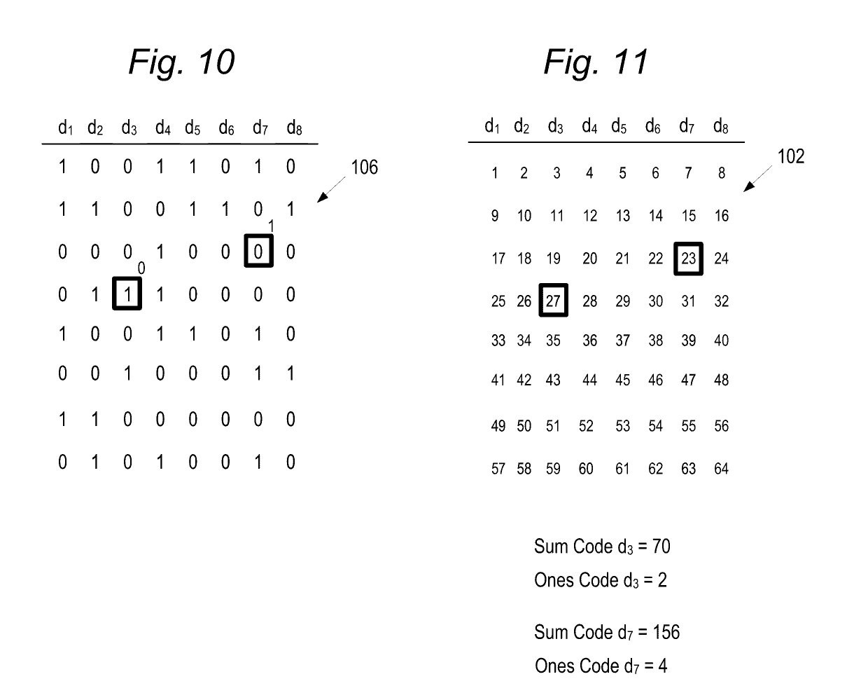

FIGS. 10 and 11 provide an example of detecting multiple bit errors using substreams. The transmitted primary code would include 8 separate sum codes and 8 separate ones code. For example, the transmitted sum code for d₃ in the transmitted data stream 100 (not shown) may be determined to be 27+43=70, and the transmitted ones code for d₃ would be 2. The transmitted sum code for d₇ in the transmitted data stream 100 would be 7+39+47+63=156, and the transmitted ones code for d₇ would be 4. The remaining sum codes and ones codes for the remaining substreams would similarly be determined.

Upon receiving the transmission, the substreams in received data stream 106 (FIG. 10) would be used to generate the ones and sum codes, which would show that the received ones codes for d₃ and d₇ were both off by exactly 1 relative to the transmitted ones codes for the different substreams. Thus, the sum code syndrome for d₃ would be determined and found to be +27, indicating that the bit associated with the 27^{th} index value is corrupt in the received data stream 106 and needs to be flipped from a ‘1’ to a ‘0’. Similarly, the sum code syndrome for d₇ would be determined and found to be −23, indicating that the bit associated with the 23^{rd} index value is corrupt in the transmitted data stream 106 and needs to be flipped from a ‘0’ to a ‘1’. The transmitted and received ones codes and sum codes for the remaining substreams would match, indicating that there were no errors in these substreams.

As noted, fewer or greater than 8 substreams may be used in further examples. As also noted, the present technology may not be able to correct multiple incorrect bits if the incorrect bits appeared in the same substream. However, the present technology may identify that an error had occurred, which in and of itself is valuable and useful information. At that point, the received data stream may be re-transmitted for example to prevent the errors from crashing an application.

While the above provides a useful method for detecting multiple bit errors, the transmission of the n separate transmitted sum codes and ones codes for the n separate substreams takes up space within memory and bandwidth to transmit. In the above example of 8 substreams, 16 codes (8 sum codes and 8 ones codes) were transmitted. In accordance with further aspects of the present technology, n separate substreams may be generated and analyzed using less than n separate transmitted sum codes and ones codes.

For example, in accordance with aspects of the present technology, the data stream may be divided into 8 independent substreams as above, but may be analyzed using as few as 5 transmitted codes rather than 16. In this embodiment, 8 substreams may be analyzed using 4 interdependent sum codes and a single ones code. One sum code covers all bits, and the others each cover different subsets of bits. In one example, using for example the 8 substreams d₁ to d₈ shown in FIG. 10, the transmitted sum codes may be defined as follows:

Sum Code A=f(d₁, d₂, d₃, d₄, d₅, d₆, d₇, d₈)

Sum Code B=f(d₁, d₂, d₃, d₄, 0, 0, 0, 0)

Sum Code C=f(0, 0, d₃, d₄, d₅, d₆, 0, 0)

Sum Code D=f(d₁, 0, d₃, 0, d₅, 0, d₇, 0)

Thus, sum code A covers all 8 substreams. Sum code B covers the first 4 substreams d₁ to d₄ (and not d₅ to d₈). Sum code C covers substreams d₃ to d₆ (and not d₁, d₂, d₇ or d₈). And sum code D covers the odd substreams (and not the even substreams). This coverage of sum codes A-D is by way of example only, and may vary as explained below.

The transmitted data stream 100 is used to generate the above transmitted sum codes A-D. The transmitted data stream is sent along with the transmitted sum codes A-D. Upon receipt, what is referred to herein as a receiver routine in the receiving computing system calculates the received sub codes in the same manner as the transmitter routine on the transmitted data stream. The transmitted sum codes are compared to their respective received sum codes to determine the sum code syndromes for A-D, as well as a syndrome for the ones code:

Syndrome A=(received_sum_code_A−transmitted_sum_code_A)

Syndrome B=(received_sum_code_B−transmitted_sum_code_B)

Syndrome C=(received_sum_code_C−transmitted_sum_code_C)

Syndrome D=(received_sum_code_D−transmitted_sum_code_D)

Syndrome Ones=(received_ones_code−transmitted_ones_code)

Referring to Table 1 below, each of the 8 substreams in each transmitted byte is covered by a unique subset of the sum code syndrome equations:

TABLE 1

| Syndrome | d₁ | d₂ | d₃ | d₄ | d₅ | d₆ | d₇ | d₈ |
|---|---|---|---|---|---|---|---|---|
| A | x | x | x | x | x | x | x | x |
| B | x | x | x | x | | | | |
| C | | | x | x | x | x | | |
| D | x | | x | | x | | x | |

That is, substream d₁ is included in and only in sum code syndromes A, B and D. Substream d₂ is included in and only in sum code syndromes A and B. Substream d₃ is included in and only in sum code syndromes A, B, C and D. Substream d₄ is included in and only in sum code syndromes A, B and C. Substream d₅ is included in and only in sum code syndromes A, C and D. Substream d₆ is included in and only in sum code syndromes A and C. Substream d₇ is included in and only in sum code syndromes A and D. And substream d₈ is included in and only in sum code syndrome D. It is understood that the particular substreams assigned to each of the sum codes A, B, C and D is by way of example only. The sub codes may have other combinations of sub codes assigned to them respectively, with the condition that each substream be represented by a unique combination of one or more sub codes and syndromes of those sub codes.

The significance in having substreams covered by a unique combination of syndromes is that it typically allows pinpointing of the particular received substreams which contain the errors, and which bits in the received substreams contain the error. For example, assume that during transmission, a single error occurred in substream a single error occurred in substream 5, and that no other errors occurred. In the above assignment of substreams, syndromes A and B will show an error due to the error in substream d₂. Syndromes C and D do not include substream d₂, and the error in substream d₂ will not affect syndromes C and D. Syndromes A, C and D will show an error due to the error in substream d₅. Syndrome B does not include substream d₅, and the error in substream d₅ will not affect syndrome B.

In accordance with the present technology, analysis of the syndromes A-D by the receiver routine can provide the substream(s) and bit(s) that are erroneous. If for example the error was a single-bit error instead of two bits, the syndromes will be identical for each of the syndromes in which the error bit is present. For instance, if a ‘1’ bit in the 10th bit of the stream (which falls into substream d₂) is erroneously transmitted as a ‘0’, syndromes A & B will both be −10 because 10 was added to the transmitted sum code but not to the received sum code. Syndromes C and D will be 0.

The present technology may also identify 2-bit errors. For example, a 2-bit error in bits received substreams d₇ and d₈ will cause syndrome D to be off by the value of the index for the d₇ error. However syndrome A will be off by the sum of the syndromes that would have been generated by the d₇ and d₈ errors. For example, if the d₇ error contributes +15 and the d₈ error contributes +24, syndrome D would be +15 and syndrome A would be +39. Syndromes B and C do not include either of substreams d₇ and d₈ errors. Thus, in this example, syndromes B and C are both 0. If analysis shows that syndrome D points to index 15, +15 can be subtracted from syndrome A to recover the value of +24. If one of the two values added to syndrome A is negative, the result will be the difference, rather than the sum, of the index values of the error locations.

The above example is simplistic, because d₈ affects only one syndrome. In other examples, the set of 45 possible error scenarios is analyzed. In particular, there are 37 possible correctable combinations of 0-bit, 1-bit, and 2-bit errors between 8 substreams:
1 combination of 0-bit errors,
8 combinations of 1-bit error (d₁, . . . d₈), and
28 combinations of 2-bit errors (d₁ and d₂, d₁ and d₃, d₇ and d₈).

There are also 8 uncorrectable combinations of 2-bit errors where the errors occur in the same substream (d₁ and d₁, d₂ and d₂, d₈ and d₈).

It may appear that 4 syndromes can only have up to 2⁴=16 combinations of zero/non-zero results, which is not sufficient to distinguish between the 37 correctable cases. However, in many cases two or more of the non-zero syndromes match. As shown below, two or more syndromes for a given set of transmitted and received sum codes will at times work out to be the same non-zero values. This will occur for example where more than one syndrome encompasses one and only one bit error. In accordance with the present technology and as shown below with respect to Table 2, checking for matching between non-zero syndromes allow reduction in the number of syndromes needed to distinguish between all 37 cases. The matching of non-zero syndromes in combination with zero/non-zero syndrome differentiation is sufficient to distinguish between all 37 cases.

In accordance with the above, analysis of the syndromes A-D is able to identify and correct 1-bit and 2-bit errors where the errors do not occur in the same substream. Specifically, the Table 2 below shows the determined syndrome matching formulas for correcting 1-bit and 2-bit errors for different syndromes A-D, and the syndrome for the ones code. In the Table 2 below:
z represents a value of zero;
two or more m's in a given syndrome represent matching values, and two n's in a given syndrome represent matching values, but m≠n when appearing in the same syndrome;
p, q, and r in a given syndrome represent non-matching, non-zero values.

TABLE 2

| Syndrome | | | | | | Error stream | | Error index formula | | |
|---|---|---|---|---|---|---|---|---|---|---|
| A | B | C | D | Ones | Notes | 1^{st} | 2^{nd} | 1^{st} | 2^{nd} | Alt |
| z | z | z | z | 0 | no error | — | — | — | — | — |
| m | m | z | m | ±1 | | 1 | — | A | — | BD |
| m | m | z | z | | | 2 | — | A | — | B |
| m | m | m | m | | | 3 | — | A | — | BCD |
| m | m | m | z | | | 4 | — | A | — | BC |
| m | z | m | m | | | 5 | — | A | — | CD |
| m | z | m | z | | | 6 | — | A | — | C |
| m | z | z | m | | | 7 | — | A | — | D |
| p | z | z | z | | | 8 | — | A | — | |
| m | m | z | p | 0 | | 1 | 2 | D | A − D | |
| m | m | p | m | or ±2 | | 1 | 3 | C | A − C | |
| m | m | p | q | | m = p + q | 1 | 4 | C | A − C | D |
| m | p | q | m | | | 1 | 5 | C | A − C | B |
| p | m | q | m | | m = p + q | 1 | 6 | B | A − B | CD |
| m | p | z | m | | | 1 | 7 | B | A − B | |
| p | m | z | m | | | 1 | 8 | B | A − B | D |
| m | m | n | n | | | 2 | 3 | C | A − C | D |
| m | m | p | z | | | 2 | 4 | C | A − C | |
| p | q | m | m | | p = q + m | 2 | 5 | B | A − B | CD |
| p | q | r | z | | p = q + r | 2 | 6 | B | A − B | C |
| p | q | z | r | | p = q + r | 2 | 7 | B | A − B | D |
| p | q | z | z | | | 2 | 8 | B | A − B | |
| m | m | m | p | | | 3 | 4 | D | A − D | D |
| m | p | m | m | | | 3 | 5 | B | A − B | C |
| m | n | m | n | | | 3 | 6 | B | A − B | D |
| m | n | n | m | | | 3 | 7 | B | A − B | C |
| p | m | m | m | | | 3 | 8 | D | A − D | BC |
| m | p | m | q | | m = p + q | 4 | 5 | B | A − B | D |
| m | p | m | z | | | 4 | 6 | B | A − B | D |
| p | m | m | q | | p = q + m | 4 | 7 | B | A − B | C |
| p | m | m | z | | | 4 | 8 | B | A − B | C |
| m | z | m | p | | | 5 | 6 | D | A − D | D |
| m | z | p | m | | | 5 | 7 | C | A − C | C |
| p | z | m | m | | | 5 | 8 | D | A − D | D |
| p | z | q | r | | p = q + r | 6 | 7 | C | A − C | D |
| p | z | q | z | | | 6 | 8 | C | A − C | |
| p | z | z | q | | | 7 | 8 | D | A − D | |

| | |
|---|---|
| anything else | not correctable |

The “Error stream” in Table 2 are the bit positions within the 8-bit field where the error(s) occurred. This information may also be derived from the result of the “Error index formula.” The “Error index formula” are suggested equations to calculate the bit positions within the received data stream where the error(s) occurred. “Alt” are alternate formulas to calculate the location of bit error index 1, while bit error 2, when a 2-bit error exists, may be calculated as syndrome A minus the syndrome used for error 1. Syndrome A, in the current example, includes all of the substreams and therefore may be used because it is a “catchall.” The receiver routine may also verify that the sign bit of the Error index formula differs from the transmitted data bit in that location. Otherwise, it is an uncorrectable error and falls under “anything else.”

Operation of the receiver routine for detecting and correcting errors in a received data stream using Table 2 will now be described with reference to the flowchart of FIG. 12. The receiver routine receives the data stream 106 (step 236) and calculates syndromes A, B, C & D (step 238) and the syndrome for the ones code (step 240). In step 244, the receiver routine determines any zero values for syndromes A, B, C and D. In step 246, the receiver routine compares each syndrome A, B, C and D against every other syndrome A, B, C and D and determines all matches (syndromes of matching value).

In step 250, the receiver routine checks whether all the syndromes (A, B, C, D and the ones syndrome) are zero. If so, this indicates that there are no data errors in the received stream and the receiver routine outputs the received data stream (step 252). The received sum codes and/or received ones code may or may not be output with the received data stream. The output stream may be stored, or processed by an application making use of the data stream.

Assuming there are non-zero values in one or more syndromes in step 250, the receiver routine looks up the zeros, matches, non-matches and ones code in a stored version of Table 2, and calculates the error index locations for correctable errors. In step 258, the receiver routine determines whether the errors are correctable. For example, if the ones code syndrome is outside of the range ±2, or if the z, m, n, p, q, r values fall outside of those set forth on Table 2, the errors may not be correctable.

If correctable errors are indicated by the Table 2 in step 258, the receiver routine identifies the index locations from Table 2 (step 262) and calculates the polarity (step 264). Polarity refers to whether the error bit is to be corrected by 0→1 or 1→0. Optionally, receiver routine may compare the polarity of the errors in step 268 to the transmitted bits in the indicated error positions, further verifying that the errors are correctable. If correctable errors are indicated by step 258 and (optionally) step 268, the receiver routine inverts the data at the determined error locations in the transmitted data stream (step 272) and outputs the corrected data stream (step 274), with or without the received sum codes and ones codes. As noted, step 268 may be omitted in further embodiments.

If uncorrectable errors are indicated by the table lookup (step 258) or by the polarity comparison (step 268), one or more actions may be taken by the receiver routine such as for example marking the stream as invalid, requesting a retransmission of the stream, or other actions.

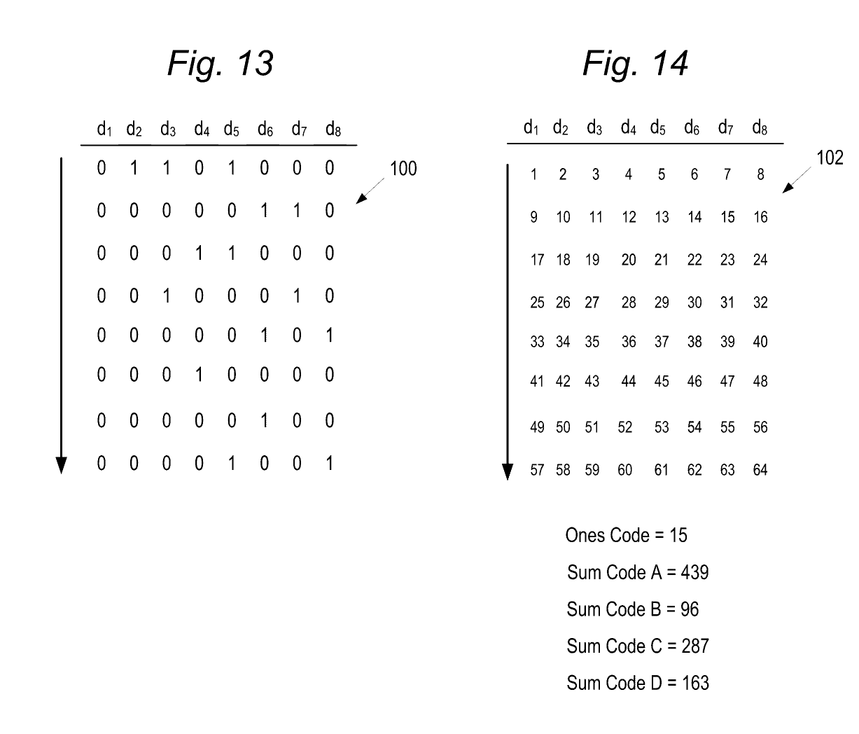

FIGS. 13-18 illustrate an example of the present technology locating and correcting two error bits in a received data stream, using eight substreams but only five syndromes: sum code syndromes A-D and a ones code syndrome. In this example, there are relatively few ‘1’ bits for simplicity, but the transmitter and receiver routines work for any size data stream with any number of ‘1’ bits.

FIGS. 13-14 illustrate the encoding routing for a transmitted data stream 100. The arrow shows the order in which bytes are transmitted. Each byte is divided into one of 8 substreams. FIG. 14 shows the index values corresponding to ‘1’ bits in FIG. 13 as being shaded. The ones code is determined by counting the ‘1’ bits across all substreams. In this example, there are 15 ‘1’ bits in the transmitted data stream. Thus, the transmitted ones code=15.

The transmitted sum codes A, B, C and D may next be determined:

Sum Code A=Σd₁, d₂, d₃, d₄, d₅, d₆, d₇, d₈

Sum Code A=2+3+5+14+15+ . . . +64=439

Sum Code B=Σd₁, d₂, d₃, d₄

Sum Code B=2+3+20+27+44=96

Sum Code C=Σd₃, d₄, d₅, d₆

Sum Code C=3+5+14+20+ . . . +61=287

Sum Code D=Σd₁, d₃, d₅, d₇

Sum Code D=3+5+15+21+ . . . +61=163

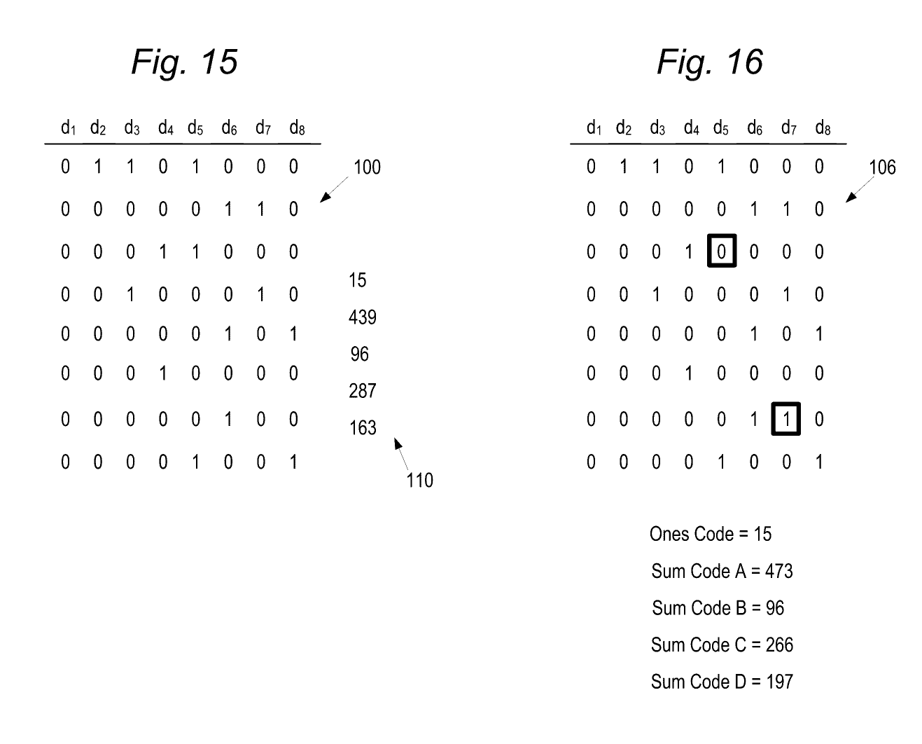

FIG. 15 shows the transmitted data stream block 100 along with its five codes 110 for transmission. FIG. 16 shows the received data stream 106 after transmission. In the received data stream 106, there were two random transmission bit errors, occurring at bits 21 and 55 as indicated by FIGS. 16 and 17. The errors are highlighted in FIGS. 16 and 17, but the receiver routine would be unaware of these errors upon transmission.

The receiver routine calculates the received ones code and the received sum codes A, B, C and D.

Received ones code=15

Received sum code A=Σd₁, d₂, d₃, d₄, d₅, d₆, d₇, d₈

Received sum code A=2+3+ . . . +20+27+ . . . +54+55+ . . . +64=473

Sum Code B=Σd₁, d₂, d₃, d₄

Sum Code B=2+3+20+27+44=96

Sum Code C=Σd₃, d₄, d₅, d₆

Sum Code C=3+5+14+20+27+ . . . +61=266

Sum Code D=Σd₁, d₃, d₅, d₇

Sum Code D=3+5+15+27+ . . . +31+55+61=197

The syndromes may next be calculated by subtracting the transmitted ones and sum codes from the received ones and sum codes:

| | Rec'd. | Trans. | Syndrome | Table Value |
|---|---|---|---|---|
| Ones Code | 15 | 15 | 0 | 0 |
| Sum Code A | 473 | 439 | +34 | m (match) |
| Sum Code B | 96 | 96 | 0 | z (zero) |
| Sum Code C | 266 | 287 | −21 | p (non-match) |
| Sum Code D | 197 | 163 | +34 | m (match) |

Thus, the table value for the ones syndrome in the above example is 0, and the four table values for the syndromes A, B, C and D are m, z, p, m, respectively. A portion of Table 2 is recreated below.

| Syndrome | | | | | | Error stream | | Error index formula | | |
|---|---|---|---|---|---|---|---|---|---|---|
| | A | B | C | D | Ones | 1^{st} | 2^{nd} | 1^{st} | 2^{nd} | Alt |
| | m | z | m | p | 0 or ±2 | 5 | 6 | D | A − D | D |
| → | m | z | p | m | | 5 | 7 | C | A − C | C |
| | p | z | m | m | | 5 | 8 | D | A − D | D |

As seen, the table value 0 for the ones syndrome, and m, z, p, m for syndromes A-D, correspond to the highlighted line from the portion of Table 2 reproduced above. Thus, the receiver routine is able to determine from the table that the error bits are in the 5^{th} and 7^{th} received substreams. Further, the error index formula indicates that the first error bit is given by syndrome C. Syndrome C=−21. Thus, the first error bit is at index 21. The polarity (the negative sign) also indicates that the 21^{st} bit in the received data stream should be flipped from a ‘0’ to a ‘1’. This can be used as a check, in that if the 21^{st} bit is already a ‘1’ in the received data stream, this may indicate that there are more than 2 bit errors, in which case the errors are noted but may not be correctable.

The error index formula further indicates that the second bit error is given by syndrome A−syndrome C.

Second bit error=syndrome A−C=+34−(−21)=+55

Thus, the second bit error is at index 55. The polarity (the positive sign) also indicates that the 55^{th} bit in the received data stream should be flipped from a ‘1’ to a ‘0’. This again can be used as a check, in that if the 55^{th} bit is already a ‘0’ in the received data stream, there are more than 2 bit errors, in which case the errors are detected but may not be correctable.

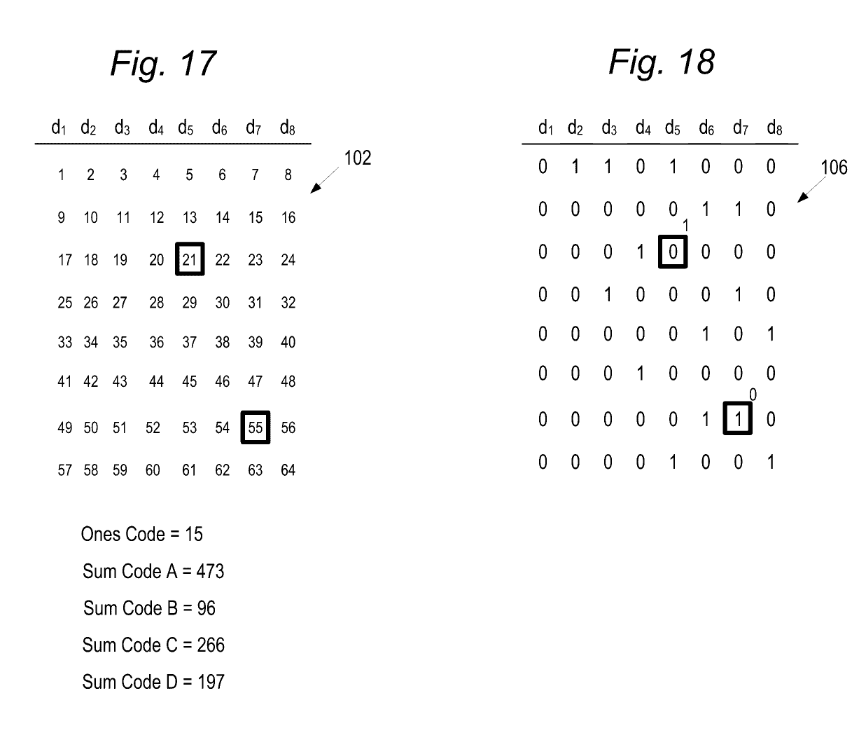

As seen in FIGS. 17 and 18, the 21^{st} bit in the received data stream 106 was in fact (erroneously) a ‘0’, and the 55^{th} bit in the received data stream was in fact (erroneously) a ‘1’. Thus, the receiver routine next corrects the 21^{st} bit from a ‘0’ to a ‘1’, and the receiver routine corrects the 55^{th} bit from a ‘1’ to a ‘0’. The corrected data stream may then be stored, transmitted again and/or processed by an application making use of the data stream.

The above description derives transmitted and received sum codes and ones codes, from which sum code syndromes and ones code syndromes may be calculated uniquely indicating bit errors in a received data stream or substreams. However, in further embodiments, the present technology may use other codes, instead of or in addition to at least one of the sum code and ones code, from which a syndrome may be calculated uniquely indicating bit errors in a received data stream or substreams.

That is, other codes (“transmitted codes”) may be used which result in a first numerical value in which each index value for ‘1’ bits or ‘0’ bits in the transmitted data stream is uniquely represented. A plurality of these transmitted codes may be used where the transmitted data stream is divided into substreams. For example, the transmitted code may be generated using other mathematical functions in addition to or other than simple addition of the index values on the transmitted data stream (or respective substreams) in which each index value for the ‘1’ bits or ‘0’ bits is uniquely represented.

The same code may be performed on the received data stream (“received code”), resulting in a second numerical value in which each index value for ‘1’ bits or ‘0’ bits in the received data stream is uniquely represented. A plurality of these received codes may be used where the received data stream is divided into substreams. The syndrome(s) representing the difference in the first and second numerical values may then be calculated, and the bit errors in the received data stream or respective substreams derived from the syndrome(s) as explained above.

In the above description, five syndrome code words are used to provide the ability to correct 92.5% of all 2-bit error in a data stream block of arbitrary size. The errors that cannot be corrected are those in which the two errors coincidentally fall within the same substream, which in a random case happens 1 time in 8. This probability can be increased from 92.5% to 98.4% by the use two independent sets of syndromes. This may be accomplished by rotating the transmitted data stream by a number of bits from 0 to 7 and performing the standard syndrome calculations independently on both the rotated and unrotated data. The number of bits by which to rotate the transmitted data stream can change with each sample or in any other manner by which the distribution of rotations used is roughly equal.

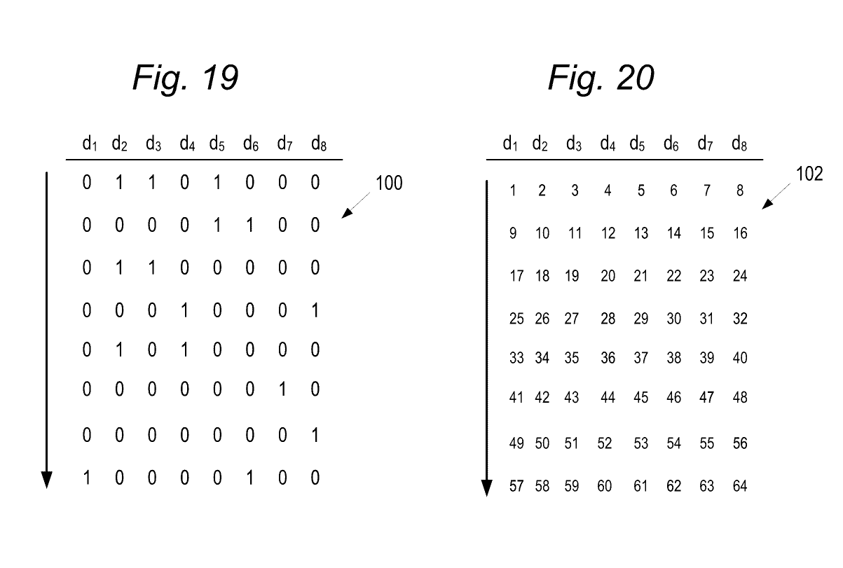

For example, FIGS. 19 and 20 show the same data stream as in FIGS. 13 and 14, but the data in each successive byte of data in FIG. 19 is rotated by one bit more than was the previous byte. That is, the first byte of data may be transmitted in the same order as the first byte of data in the data stream of FIG. 13. The second byte of data is transmitted such that, what was previously the first bit (d₁) is transmitted instead as the last bit (d₈), and the remaining data bits have been shifted (rotated) one position left. The third byte of data is transmitted such that, what was previously the first two bits (d₁ and d₂) are transmitted as the last bits (d₇ and d₈), and the remaining data bits have been rotated two positions left. This rotation continues for the remaining bytes of data, with the number of bits of rotation incrementing by one for each successive byte.

This has the effect of shuffling which bits in the data stream fall into which substreams. The transmitter and receiver routines perform the same operations on the rotated data as described above. The ones and sum code syndromes are determined on the data stream as described above, and the error bits may be determined from the Table 2 as described above.

Rotating or shifting is merely one example of how the data may be shuffled and redistributed into different substreams. Other examples, including a randomization of the data in a given data stream block, would work as well, with the provision that the transmitter and receiver routines operate on the data in the same positions.

For either the rotated or unrotated data, those cases where both errors occur in the same substream may be easily detected because the ones code syndrome will either be ±2 (if both errors were of the same polarity, such as 0→1) or 0 (if they were of different polarity), but the syndrome look-up table will specify 1 error.

If independent sets of syndromes are calculated for the unrotated and rotated data, the probability that the 2 errors are in the same substream for both sets of syndromes falls from 1/8 to 1/64. In the more likely case where the 2 errors are in the same substream for just one of the two sets of syndromes, the look-up table (Table 2) will specify 2 errors for one set and 1 error for the other set. The set of syndromes that specify 2 errors would be used in this case, ignoring the other set as incorrect.

The Table 3 below shows how to interpret data from the two syndrome sets:

TABLE 3

| | | | Decoded | |
|---|---|---|---|---|
| | | | error | |
| Ones | Look-up table syndrome ones | | location(s) | |
| Count | Syndrome | Syndrome | for sets | |
| error | set A | set B | A & B | Assumption |
| 0 | 0 | 0 | (none) | No errors |
| ±1 | 1 | 1 | Match | 1 error, correct |
| | | | | using either set |
| 0 | 2 | 2 | Match | 2 errors, correct |
| or ±2 | | | | using either set |
| | 2 | 1 | (won't | 2 errors, correct |
| | | | match) | using set “A” |
| | 1 | 2 | | 2 errors, correct |
| | | | | using set “B” |

| | |
|---|---|
| Anything else | Not correctable |

The above description operates where the received primary code (sum code one and ones code) data itself is error-free. If there were an error in the received primary code, the data correction would be performed incorrectly, or an error would be introduced into correctly received data bits. Therefore, in further embodiments, the primary code may be protected against transmission error by also performing the transmitter and receiver routines on the primary code itself

This algorithm is designed to correct all 1-bit and most 2-bit errors. A 1-bit error can take place in the data or in the primary code, while a 2-bit error can take place in the data, in the primary code, or in both. However, an error limited to the primary code is harmless as long as it is detected.

The same routines as described above to protect the data stream may be used to protect the primary code. The up to 64 bits of primary code data are run through the same routines used to produce sum code A to produce a 7-bit code, referred to herein as the secondary code. This code is sufficient to correct any single-bit error in the 64 bits of the primary code. To further protect the secondary code, a simple checksum (XOR) of its 7 bits may be placed into the 8th bit.

With the checksum bit in the secondary code, single-bit errors in the secondary code can be detected. If the secondary code fails the checksum, the secondary code may not be used to correct the primary code. Otherwise, if the received secondary code does not match the transmitted secondary code, they may be used to correct the received primary code before it is compared to the transmitted primary code. In embodiments, no attempt is made to correct errors in the secondary code, and no attempt is made to correct 2-bit errors in the primary code, because transition errors in the codes are not necessarily harmful.

In the above example of a data stream of 1K bytes, the primary code may be packed into no more than 64 bits, otherwise the secondary code plus checksum will require more than 8 bits. The sum codes A, B, C & D each requires 15 bits. Therefore, it is recommended to pack the ones code into 3 of the remaining 4 bits to form the primary code. Optionally, a checksum of the primary code, which will not be used in calculation of the secondary code, can be used as the 64th bit.

Table 4 is one possible implementation of the code block transmitted with the data stream.

TABLE 4

| | | | | | | | | |
|---|---|---|---|---|---|---|---|---|
| Byte | 7 | 6 | 5 | 4 | 3 | 2 | 1 | 0 |

| 1 | Code A [7:0] | |
|---|---|---|
| 2 | 1s[0] | Code A[14:8] |
| 3 | Code B [7:0] | |
| 4 | 1s[1] | Code B[14:8] |
| 5 | Code C [7:0] | |
| 6 | 1s[2] | Code C[14:8] |
| 7 | Code D[7:0] | |
| 8 | C1 | Code D[14:8] |
| 9 | C2 | Code 2[6:0] |

where:
1s indicates the ones code;
Code 2 indicates the secondary code;
C1 indicates parity across the remaining 63 bits of bytes 1-8; and
C2 indicates even parity across the secondary code.

The technology described above may be used to identify and correct 1 bit and 2 bits errors in a data stream of arbitrary length. However, in further embodiments, the present technology may be used to detect, and possibly correct, 3 bit errors or more. A look-up table may be generated which will provide the substreams, and index values of the 3 bit errors, in a manner analogous to that described above for 2 bit errors.

It is understood that the transmission of the transmitted data bits and code bits may be preceded by further processing steps for reasons including but not limited to data compression, data security, clock recovery, and DC level balancing, such that the physical bits that get transmitted bears some, little or no resemblance to the original data and code bits, provided however that further processing to recover the original data and code bits is performed at the receiver prior to calculation of the received codes.

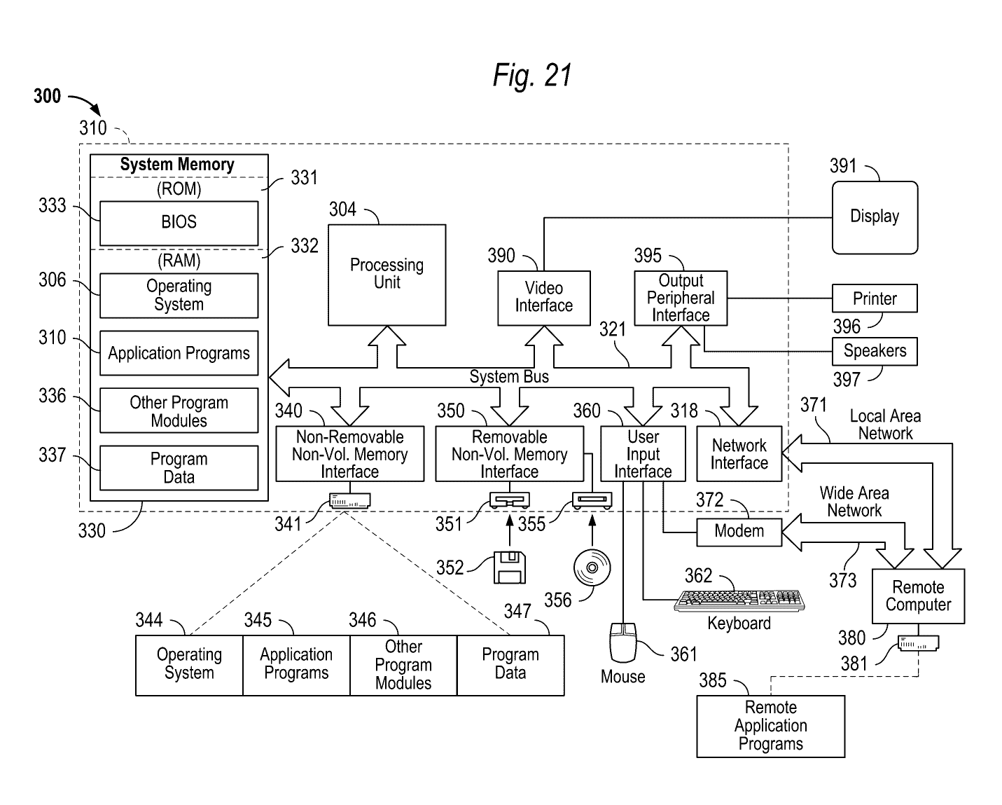

FIG. 21 illustrates a computing system 300 for storing, transmitting and/or receiving data streams, and for executing the routines for generating the transmitted and received codes, in hardware, software or a combination of the two. As noted above, enabling the computing system 300 to work with corrected data improves the efficiency, accuracy and functionality of the computing system 300.

The computing system 300 may be a first computing system for example for generating the transmitted primary code and sending the transmitted data stream and transmitted primary code. The computing system 300 may be a second computing system for example for receiving the received data stream and generating the received primary code. In a further example, the computing system 300 may comprise both of the first and second computing systems.

The computing system 300 is one example of a suitable computing environment and is not intended to suggest any limitation as to the scope of use or functionality of the present system. Neither should the computing system 300 be interpreted as having any dependency or requirement relating to any one or combination of components illustrated in the exemplary computing system 300.

The present system is operational with numerous other general purpose or special purpose computing systems, environments or configurations. Examples of well-known computing systems, environments and/or configurations that may be suitable for use with the present system include, but are not limited to, personal computers, server computers, multiprocessor systems, microprocessor-based systems, network PCs, minicomputers, hand-held computing devices, mainframe computers, and other distributed computing environments that include any of the above systems or devices, and the like. In the distributed and parallel processing cluster of computing systems used to implement the present system, tasks are performed by remote processing devices that are linked through a communication network. In such a distributed computing environment, program modules may be located in both local and remote computer storage media including memory storage devices.

With reference to FIG. 21, an exemplary computing system 300 for use in performing the above-described methods includes a general purpose computing device. Components of computing system 300 may include, but are not limited to, a processing unit 304, a system memory 316, and a system bus 321 that couples various system components including the system memory to the processing unit 304. The system bus 321 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The system memory 316 includes computer storage media in the form of volatile and/or nonvolatile memory such as read only memory (ROM) 331 and random access memory (RAM) 332. A basic input/output system (BIOS) 333, containing the basic routines that help to transfer information between elements within computing system 300, such as during start-up, is typically stored in ROM 331. RAM 332 typically contains data and/or program modules that are immediately accessible to and/or presently being operated on by processing unit 304. By way of example, and not limitation, FIG. 21 illustrates operating system 306, application programs 310, other program modules 336, and program data 337.

The computing system 300 may also include other removable/non-removable, volatile/nonvolatile computer storage media. By way of example only, FIG. 21 illustrates a hard disk drive 341 that reads from or writes to non-removable, nonvolatile magnetic media, a magnetic disk drive 351 that reads from or writes to a removable, nonvolatile magnetic disk 352, and an optical disk drive 355 that reads from or writes to a removable, nonvolatile optical disk 356 such as a CD-ROM or other optical media. Other removable/non-removable, volatile/nonvolatile computer storage media that can be used in the exemplary operating environment include, but are not limited to, magnetic tape cassettes, flash memory cards, DVDs, digital video tape, solid state RAM, solid state ROM, and the like. The hard disk drive 341 is typically connected to the system bus 321 through a non-removable memory interface such as interface 340, and magnetic disk drive 351 and optical disk drive 355 are typically connected to the system bus 321 by a removable memory interface, such as interface 350.

The drives and their associated computer storage media discussed above and illustrated in FIG. 21 provide storage of computer readable instructions, data structures, program modules and other data for the computing system 300. In FIG. 21, for example, hard disk drive 341 is illustrated as storing operating system 344, application programs 345, other program modules 346, and program data 347. These components can either be the same as or different from operating system 306, application programs 310, other program modules 336, and program data 337. Operating system 344, application programs 345, other program modules 346, and program data 347 are given different numbers here to illustrate that, at a minimum, they are different copies.

A user may enter commands and information into the computing system 300 through input devices such as a keyboard 362 and pointing device 361, commonly referred to as a mouse, trackball or touch pad. Other input devices (not shown) may be included. These and other input devices are often connected to the processing unit 304 through a user input interface 360 that is coupled to the system bus 321, but may be connected by other interface and bus structures, such as a parallel port, game port or a universal serial bus (USB). A monitor 391 or other type of display device is also connected to the system bus 321 via an interface, such as a video interface 390. In addition to the monitor 391, computers may also include other peripheral output devices such as speakers 397 and printer 396, which may be connected through an output peripheral interface 395.

As indicated above, the computing system 300 may operate in a networked environment using logical connections to one or more remote computers in the cluster, such as a remote computer 380. The remote computer 380 may be a personal computer, a server, a router, a network PC, a peer device or other common network node, and typically includes many or all of the elements described above relative to the computing system 300, although only a memory storage device 381 has been illustrated in FIG. 21. The logical connections depicted in FIG. 21 include a local area network (LAN) 371 and a wide area network (WAN) 373, but may also include other networks. Such networking environments are commonplace in offices, enterprise-wide computer networks, intranets and the Internet.

When used in a LAN networking environment, the computing system 300 is connected to the LAN 371 through a network interface or adapter 318. When used in a WAN networking environment, the computing system 300 typically includes a modem 372 or other means for establishing communication over the WAN 373, such as the Internet. The modem 372, which may be internal or external, may be connected to the system bus 321 via the user input interface 360, or other appropriate mechanism. In a networked environment, program modules depicted relative to the computing system 300, or portions thereof, may be stored in the remote memory storage device. By way of example, and not limitation, FIG. 21 illustrates remote application programs 385 as residing on memory device 381. It will be appreciated that the network connections shown are exemplary and other means of establishing a communications link between the computers may be used.

In summary, embodiments of the present technology relate to a computing system, comprising: a processor of one or more processors operable to determine a plurality of syndromes for a plurality of substreams common to a transmitted data stream and a received data stream, the plurality of syndromes determined by the processor based at least on a comparison of a plurality of transmitted codes generated from the transmitted data stream with a plurality of received codes generated from the received data stream; transmitted codes of the plurality of transmitted codes calculated from a first set of different combinations of substreams from the transmitted data stream, and the processor operable to calculate received codes of the plurality of received codes from a second set of different combinations of substreams from the received data stream; and the processor operable to determine 1-bit or 2-bit errors in the received data stream based at least on the syndromes, using less syndromes than there are substreams by making use of matching, non-zero values in two or more of the plurality of syndromes.

In a further example, the present technology relates to a method of identifying data transmission errors in a received data stream, comprising: (a) receiving a data stream, the received data stream being a transmission or retrieval of a transmitted data stream, the transmitted data stream divided into a plurality substreams, and the transmitted data stream having index values assigned to bits in the transmitted data stream; (b) receiving a plurality of received primary codes derived from the received data stream; (c) dividing the received data stream into a plurality of substreams corresponding to the plurality of substreams in the transmitted data stream; (d) assigning bits in received data streams index values corresponding to the index values in the transmitted data stream; (e) deriving a plurality of syndromes from the plurality of transmitted primary codes and a plurality of received primary codes derived from the received data stream, the number of substreams being greater than the number of syndromes, one of each of the transmitted and received primary codes being a ones code based on at least one of the number of ‘1’ bits and ‘0’ bits in the transmitted and received data streams, and two or more of each of the transmitted and received primary codes being sum codes based on summations of index values for at least one of ‘1’ bits and ‘0’ bits in two or more distinct combination of the substreams in the transmitted and received data streams; and (f) determining 1-bit or 2-bit errors in the received data stream, where there are 1-bit or 2-bit errors and no substream having more than one error bit, said determination based at least in part on zero values, two or more non-zero matching values, and/or one or more non-zero non-matching values in syndromes of the plurality of syndromes based on the sum codes

In another example, the present technology relates to a computer readable storage medium for controlling a processor to perform a method of identifying data transmission errors in a received data stream of arbitrary length, the method comprising: (a) receiving the transmitted data stream together with a transmitted primary code derived from the transmitted data stream, the transmitted data stream having different index values associated with the respective bits in the transmitted data stream and the transmitted data stream being divided into a plurality of substreams, the transmitted primary code comprising a first ones code representing at least one of a number of ‘1’ and ‘0’ bits in the transmitted data stream, and the first primary code comprising a first plurality of sum codes representing sums of the index values for at least one of the ‘1’ bits and ‘0’ bits from one or more substreams of the plurality of substreams in the transmitted data stream, the number of sum codes in the first plurality of sum codes being less than or equal to the number of substreams; (b) determining a second primary code comprising a second ones code representing at least one of a number of ‘1’ bits and ‘0’ bits in the received data stream, and the second primary code comprising a second plurality of sum codes representing sums of the index values for at least one of the ‘1’ and ‘0’ bits from the one or more substreams of the plurality of substreams in the received data stream; and (c) determining one or more bit positions in the received data stream by comparison of the first and second ones codes and comparison of the first and second plurality of sum codes.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. It is intended that the scope of the invention be defined by the claims appended hereto.

We claim:

1. A computing system, comprising:
A processor of one or more processors operable to determine a plurality of syndromes for a plurality of substreams common to a transmitted data stream and a received data stream, the plurality of syndromes determined by the processor based at least on a comparison of a plurality of transmitted codes generated from the transmitted data stream with a plurality of received codes generated from the received data stream;
transmitted codes of the plurality of transmitted codes calculated from a first set of different combinations of substreams from the transmitted data stream, and the processor operable to calculate received codes of the plurality of received codes from a second set of different combinations of substreams from the received data stream; and
the processor operable to determine 1-bit or 2-bit errors in the received data stream based at least on the syndromes, using less syndromes than there are substreams by making use of matching, non-zero values in two or more of the plurality of syndromes.

2. The computing system of claim 1, wherein respective bits in the transmitted data stream are assigned different index values, respective bits in the received data stream having the same index value as their corresponding bit in the transmitted data stream.

3. The computing system of claim 2, the computing system comprising a first computing device and a second computing device, wherein the transmitted codes are a first set of numerical values resulting from a mathematical operation performed on the index values by the first computing device for at least one of the ‘1’ bits and ‘0’ bits in the different combinations of substreams in the first set of substreams.

4. The computing system of claim 3, wherein the received codes are a second set of numerical values resulting from the mathematical operation performed on the index values by the second computing device for at least one of the ‘1’ bits and ‘0’ bits in the different combinations of substreams in the second set of substreams.

5. The computing system of claim 4, wherein at least one of the syndromes from the transmitted and received codes gives the index value of a position of a bit error where there is at least one bit error.

6. The computing system of claim 2, wherein the transmitted codes comprise transmitted sum codes, the transmitted sum codes being a first set of numerical values resulting from summing index values for at least one of the ‘1’ bits and ‘0’ bits in the different combinations of substreams in the first set of substreams.

7. The computing system of claim 6, wherein the received codes comprise received sum codes, the received sum codes being a second set of numerical values resulting from summing index values for the at least one of the ‘1’ bits and ‘0’ bits in the different combinations of substreams in the second set of substreams.

8. The computing system of claim 1, wherein the transmitted codes comprise transmitted ones codes, the transmitted ones codes being a first set of numerical values resulting from at least one of the number of one of the ‘1’ bits and ‘0’ bits in the different combinations of substreams in the first set of substreams.

9. The computing system of claim 8, wherein the received codes comprise received ones codes, the received ones codes being a second set of numerical values resulting from at least one of the number of one of the ‘1’ bits and ‘0’ bits in the different combinations of substreams in the second set of substreams.

10. The computing system of claim 9, wherein at least one of the syndromes from the transmitted and received ones codes indicates the number of errors in the transmitted bit stream.

11. A method of identifying data transmission errors in a received data stream, comprising:
(a) receiving a received data stream, the received data stream being a transmission or retrieval of a transmitted data stream, the transmitted data stream divided into a plurality substreams, and the transmitted data stream having index values assigned to bits in the transmitted data stream;
(b) receiving a plurality of received primary codes derived from the received data stream;
(c) dividing the received data stream into a plurality of substreams corresponding to the plurality of substreams in the transmitted data stream;
(d) assigning bits in received data streams index values corresponding to the index values in the transmitted data stream;
(e) deriving a plurality of syndromes from the plurality of transmitted primary codes and a plurality of received primary codes derived from the received data stream, the number of substreams being greater than the number of syndromes, one of each of the transmitted and received primary codes being a ones code based on at least one of the number of ‘1’ bits and ‘0’ bits in the transmitted and received data streams, and two or more of each of the transmitted and received primary codes being sum codes based on summations of index values for at least one of ‘1’ bits and ‘0’ bits in two or more distinct combination of the substreams in the transmitted and received data streams; and
(f) determining 1-bit or 2-bit errors in the received data stream, where there are 1-bit or 2-bit errors and no substream having more than one error bit, said determination based at least in part on zero values, two or more non-zero matching values, and/or one or more non-zero non-matching values in syndromes of the plurality of syndromes based on the sum codes.

12. The method of claim 11, said step (f) determining 1-bit and 2-bit errors in the received data stream based at least in part on whether the syndrome based on the ones codes is equal to zero, ±1 or ±2.

13. The method of claim 11, said step (f) determining 1-bit and 2-bit errors in the received data stream comprising the step of determining the locations of the 1-bit or 2-bit errors from a stored lookup table based on the zero values, two or more non-zero matching values, and/or one or more non-zero non-matching values in the syndromes of the plurality of syndromes.

14. The method of claim 11, wherein the plurality of syndromes comprise a first plurality of syndromes, the method further comprising the steps of:
(g) assigning bits in the transmitted and received primary codes index values;
(h) deriving a second plurality of syndromes from a plurality of transmitted and received secondary codes, one of each of the transmitted and received secondary codes being a ones code based on at least the number of ‘1’ or ‘0’ bits in the transmitted and received primary code, and one of each of the transmitted and received secondary codes being sum codes based on summations of index values for one of ‘1’ and ‘0’ bits in the transmitted and received primary code;
(i) determining errors in the received primary codes based on the values of the second plurality of syndromes.

15. A computer readable storage medium for controlling a processor to perform a method of identifying data transmission errors in a received data stream of arbitrary length, the method comprising:
(a) receiving the transmitted data stream together with a transmitted primary code derived from the transmitted data stream, the transmitted data stream having different index values associated with the respective bits in the transmitted data stream and the transmitted data stream being divided into a plurality of substreams, the transmitted primary code comprising a first ones code representing at least one of a number of ‘1’ and ‘0’ bits in the transmitted data stream, and the first primary code comprising a first plurality of sum codes representing sums of the index values for at least one of the ‘1’ bits and ‘0’ bits from one or more substreams of the plurality of substreams in the transmitted data stream, the number of sum codes in the first plurality of sum codes being less than or equal to the number of substreams;
(b) determining a second primary code comprising a second ones code representing at least one of a number of ‘1’ bits and ‘0’ bits in the received data stream, and the second primary code comprising a second plurality of sum codes representing sums of the index values for at least one of the ‘1’ and ‘0’ bits from the one or more substreams of the plurality of substreams in the received data stream; and
(c) determining one or more bit positions in the received data stream by comparison of the first and second ones codes and comparison of the first and second plurality of sum codes.

16. The computer readable storage medium of claim 15, the comparison of the first and second ones code in said step (d) indicating the number of erroneous bits in the received data stream.

17. The computer readable storage medium of claim 15, wherein there is a first sum code and a second sum code for each substream in said steps (a) and (b), the comparison of the first and second sum codes for a substream identifying an index value associated with a position of a bit error in the substream where the substream includes one bit error.

18. The computer readable storage medium of claim 17, wherein the bit error is corrected for the bit associated with the identified index.

19. The computer readable storage medium of claim 18, wherein the comparison of the first and second sum codes in said step (c) results in a plurality of sum code syndromes, the plurality of sum code syndromes having numerical values that are at least one of zero, two or more non-zero matching values, and one or more non-zero non-matching values, the numerical syndrome values, together with a syndrome of the first and second ones codes, indicating the number and position of bit errors where the bit errors occur in different bit streams.

20. The computer readable storage medium of claim 15, further comprising the steps repeating said steps (a), (b) and (c) with the data stream rotated to divide the data differently into the substreams.
